(19) United States
(12) Patent Application Publication
(10) Pub. No.: US 2025/0372924 A1
(43) Pub. Date: Dec. 4, 2025

(54) Conductive Terminal Assembly and Connector

(71) Applicants: Tyco Electronics (Suzhou) Ltd., Suzhou City (CN); Tyco Electronics (Shanghai) Co., Ltd., Shangahi (CN)

(72) Inventors: Limin Gao, Suzhou (CN); Feng (Charles) Wan, Shanghai (CN); Kai (Rik) Chen, Suzhou (CN); Xiaowei Deng, Suzhou (CN)

(73) Assignees: Tyco Electronics (Suzhou) Ltd., Suzhou City (CN); Tyco Electronics (Shanghai) Co., Ltd., Shanghai (CN)

(21) Appl. No.: 19/221,889

(22) Filed: May 29, 2025

(30) Foreign Application Priority Data
May 30, 2024 (CN) 202421210612.9

(51) Int. Cl. H01R 13/6582; H01R 13/24; H01R 13/502; H01R 13/631

(52) U.S. Cl. CPC H01R 13/6582; H01R 13/2407; H01R 13/502; H01R 13/631

(57) ABSTRACT

A conductive terminal assembly includes a conductive terminal, a sleeve, and a locking structure. The conductive terminal has an end with an insertion portion. The insertion portion has an insertion cavity receiving a mating terminal. The sleeve is sleeved on an outside of the insertion portion. The locking structure fixes the sleeve and the insertion portion together. The locking structure has a protrusion protruding from one of a side wall of the insertion portion and a side wall of the sleeve towards the other. The protrusion is engaged with another of the side wall of the insertion portion and the side wall of the sleeve to suppress a movement of the sleeve relative to the insertion portion.

### CROSS-REFERENCE TO RELATED APPLICATION

This application claims the benefit of the filing date under 35 U.S.C. § 119 (a)-(d) of Chinese Patent Application No. 202421210612.9, filed on May 30, 2024, the whole disclosure of which is incorporated herein by reference.

### FIELD OF THE INVENTION

Embodiments of the present disclosure relate to a conductive terminal assembly and, more particularly, to a conductive terminal assembly and a connector including the conductive terminal assembly.

### BACKGROUND OF THE INVENTION

Existing conductive terminals with sleeves are common conductive terminal assemblies in connectors, wherein a sufficient holding force between the sleeve and the conductive terminal is necessary and crucial. An external surface of the conductive terminal and an internal surface of the sleeve are typically fitted by a surface interference fit to provide the holding force between the two. However, the surface interference fit is highly sensitive to dimensional and shape variations, which often leads to some issues during production, such as assembly difficulties and insufficient holding force.

### SUMMARY OF THE INVENTION

A conductive terminal assembly includes a conductive terminal, a sleeve, and a locking structure. The conductive terminal has an end with an insertion portion. The insertion portion has an insertion cavity receiving a mating terminal. The sleeve is sleeved on an outside of the insertion portion. The locking structure fixes the sleeve and the insertion portion together. The locking structure has a protrusion protruding from one of a side wall of the insertion portion and a side wall of the sleeve towards the other. The protrusion is engaged with another of the side wall of the insertion portion and the side wall of the sleeve to suppress a movement of the sleeve relative to the insertion portion.

### BRIEF DESCRIPTION OF DRAWINGS

The invention will now be described by way of example with reference to the accompanying figures, of which:

FIG. 1 is a perspective view of a structure of a conductive terminal assembly according to an exemplary embodiment;

FIG. 2 is a sectional side view of a structure of a conductive terminal assembly according to another exemplary embodiment;

FIG. 3 is a perspective view of a structure of a conductive terminal of the conductive terminal assembly of FIG. 2;

FIG. 4 is a sectional perspective view of a conductive terminal assembly according to another exemplary embodiment;

FIG. 5 is a perspective view of a structure of a conductive terminal assembly according to another exemplary embodiment;

FIG. 6 is a perspective view of a structure of a conductive terminal of a conductive terminal assembly according to another exemplary embodiment; and

FIG. 7 is a sectional end view of a conductive terminal of a conductive terminal assembly according to another exemplary embodiment.

### DETAILED DESCRIPTION

Although the present disclosure will be fully described with reference to the drawings containing embodiments of the present disclosure, it should be understood that those skilled in the art can modify the description herein to obtain the technical effects of the present disclosure. Therefore, it must be recognized that the below description is a broad revelation to those skilled in the art, and the below description is not intended to limit the exemplary embodiments described herein.

In addition, in the following detailed description, for the sake of explanation, numerous specific details are set forth in order to provide a thorough understanding of the disclosed embodiments. It will be apparent, however, that one or more embodiments may also be practiced without these specific details. In other instances, well-known structures and devices are illustrated schematically in order to simplify the drawing.

It should be noted that, the word “comprise” or “include” do not exclude other elements or steps, and the word “a” or “an” do not exclude more than a plurality. In addition, any reference numerals in the claims should not be interpreted as limiting the scope of the present disclosure.

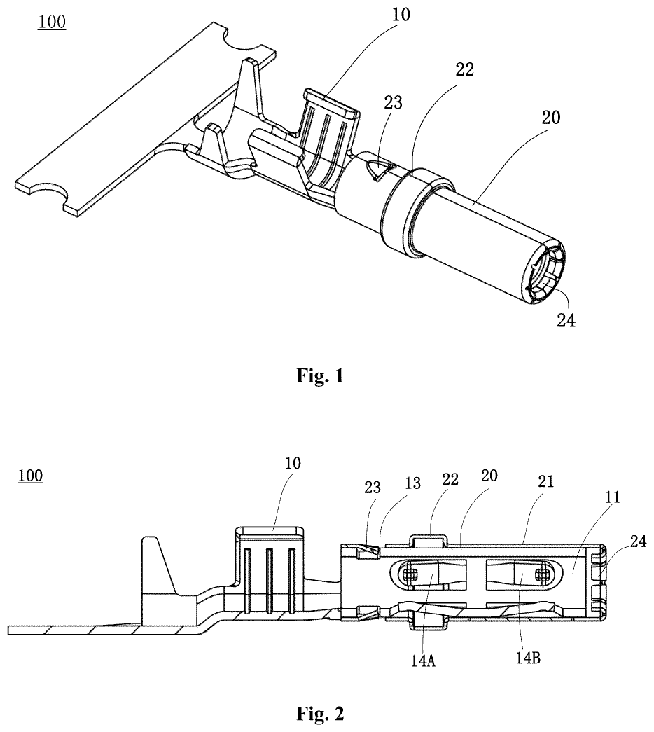

An exemplary embodiment of a conductive terminal assembly 100 will now be described with reference to FIG. 1. As shown in FIG. 1, the conductive terminal assembly 100 comprises a conductive terminal 10. One end of the conductive terminal 10 is provided with a cylindrical insertion portion 11, shown in FIG. 2, which has an insertion cavity for insertion of a mating terminal. In other words, the insertion portion 11 has the insertion cavity which receives the mating terminal. The conductive terminal assembly 100 further includes a sleeve 20 that is sleeved on an outside of the insertion portion 11. The sleeve 20 provides a certain holding force for the conductive terminal 10 to maintain stable contact between the conductive terminal 10 and the mating terminal.

As shown in FIG. 1, the conductive terminal assembly 100 further comprises a locking structure that fixes the sleeve 20 and the insertion portion 11 together. The locking structure includes a protrusion 23 that protrudes from a side wall of the sleeve 20 towards a side wall of the insertion portion 11. The protrusion 23 is engaged with the side wall of the insertion portion 11 to suppress a movement of the sleeve 20 relative to the conductive terminal 10. Compared to the existing technical solution where the sleeve and the conductive terminal are in a surface interference fit, the conductive terminal assembly 100 according to exemplary embodiments of the present disclosure has an interference between the sleeve 20 and the conductive terminal 10 only at the protrusion 23, thereby reducing the sensitivities of the conductive terminal assembly 100 to dimensional and shape variations, improving the production efficiency, and reducing manufacturing cost.

It should be noted that, in some other embodiments of the present disclosure, the protrusion 23 may also be formed on the side wall of the insertion portion 11. When the protrusion 23 is formed on the side wall of the insertion portion 11, it protrudes towards and interferes with the side wall of the sleeve 20, thereby fixing the sleeve 20 and the conductive terminal 10 together.

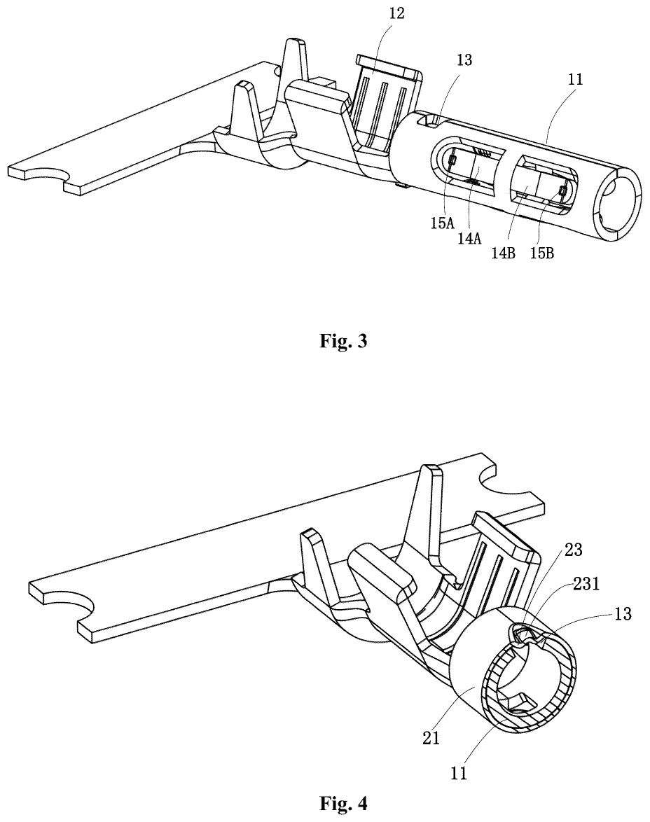

Another exemplary embodiment of a conductive terminal assembly 100 will now be described with reference to FIGS. 2-3. As shown in FIGS. 2-3, the protrusion 23 is in the form of a clip 23. In other words, the protrusion 23 is formed in the shape of a clip 23. The locking structure also includes a groove 13 formed in the side wall of the insertion portion 11. The sleeve 20 and the conductive terminal 10 are fixed together by the engagement of the clip 23 and the groove 13, thereby enhancing the reliability of the connection between the sleeve 20 and the conductive terminal 10. It should be noted that in other embodiments of the present disclosure, the clip 23 may be formed on the insertion portion 11, and the groove 13 can be formed in the side wall of the sleeve 20.

Another exemplary embodiment of a conductive terminal assembly 100 will now be described with reference to FIG. 4. According to the exemplary embodiment shown in FIG. 4, a rib 231 is formed on the clip 23 to improve the strength of the clip 23 and increase the holding force, thereby improving the reliability of the connection between the conductive terminal 10 and the mating terminal.

According to the exemplary embodiment shown in FIG. 2, the clip 23 may be a segment that extends obliquely from the side wall of the sleeve 20 towards an insertion opening and towards a center axis of the sleeve 20. In other words, the protrusion 23 is formed in a shape of a shrapnel. The groove 13 may be in the form of a through-hole (as shown in FIG. 1) or a blind hole. It should be noted that the clip 23 and the groove 13 may also adopt other structures.

According to the exemplary embodiment shown in FIG. 1, the protrusion 23 is formed by bending an end of the sleeve 20 away from the insertion opening of the insertion cavity towards the insertion portion 11. It should be noted that when the protrusion 23 is formed on the insertion portion 11, the protrusion 23 can also be formed by bending an end of the insertion portion 11 away from the insertion opening of the insertion cavity towards the sleeve 20.

According to the exemplary embodiment shown in FIG. 2, there are a plurality of locking structures 13, 23 arranged at intervals along a circumferential direction of the sleeve 20, to increase the holding force, thereby improving the reliability of the connection between the conductive terminal 10 and the mating terminal, and making the insertion portion 11 more uniformly stressed in the circumferential direction.

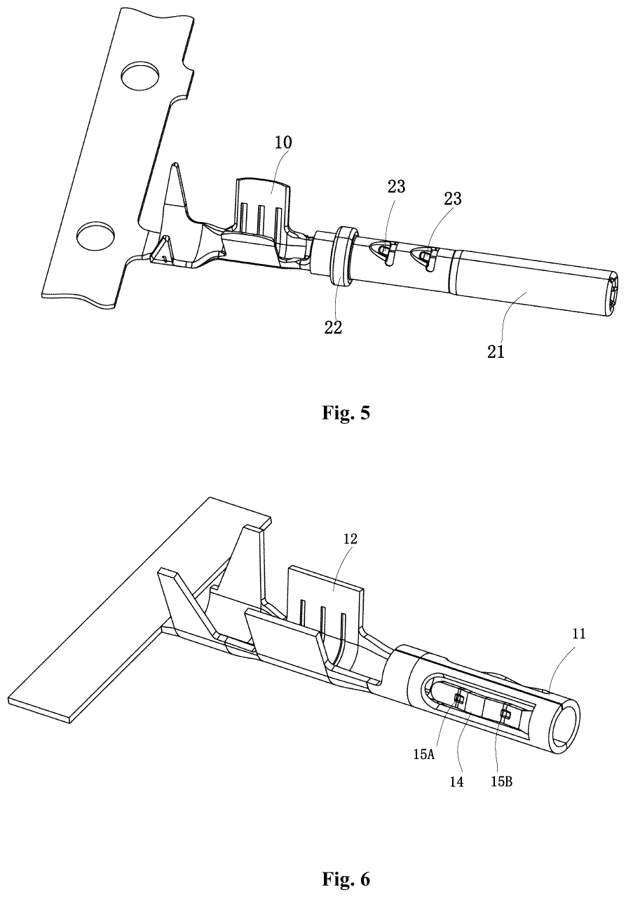

Another exemplary embodiment of a conductive terminal assembly 100 will now be described with reference to FIG. 5. As shown in FIG. 5, there are a plurality of locking structures 13, 23 arranged at intervals along an axial direction of the sleeve 20, to increase the holding force, thereby improving the reliability of the connection between the conductive terminal 10 and the mating terminal, and making the insertion portion 11 more uniformly stressed in the axial direction.

According to the exemplary embodiments shown in FIGS. 2 and 5, the sleeve 20 includes a substantially cylindrical sleeve body 21 and a locking boss 22 that protrudes radially and outwardly from the sleeve body 21. This locking boss 22 can be engaged with the housing of the connector to fix the conductive terminal assembly 100 within the housing of the connector.

According to an exemplary embodiment, the conductive terminal assembly 100 is fixed in the housing of the connector by forming the locking boss 22 on the sleeve 20 that is engaged with the housing of the connector. This avoids machining of a boss on the conductive terminal 10, which helps reduce the length of the terminal and thus reduces the cost. In addition, since the material hardness of the sleeve 20 is typically greater than that of the conductive terminal 10 and the thickness of the sleeve 20 is typically less than that of the conductive terminal 10, the metal sliver issue is reduced or eliminated during the processing of the conductive terminal assembly 100.

According to another exemplary embodiment, the locking boss 22 includes a first locking boss and a second locking boss provided at intervals along the axial direction of the sleeve 20. In this way, the first locking boss can be engaged with the housing of the connector to form a primary locking structure that locks the conductive terminal assembly 100 to the housing of the connector is provided. At the same time, the second locking boss can also be engaged with the housing of the connector to form a secondary locking structure that further locks the conductive terminal assembly 100 to the housing of the connector is provided. It should be noted that in some other embodiments of the present disclosure, the number of locking bosses 22 can be other values, such as three or four, and the specific number can be designed according to the specific situation.

According to the exemplary embodiments shown in FIGS. 1-2, one end of the sleeve 20 corresponding to the insertion opening of the insertion cavity of the conductive terminal 10 is bent into the insertion cavity, to form a stopper 24, which is used to stop a forward movement of the conductive terminal 10 (i.e., towards the right side in FIG. 2).

According to an exemplary embodiment, the sleeve 20 may be formed by bending a sheet metal. In addition, in order to ensure the strength of the sleeve 20, the material of the sleeve 20 is a stainless steel. In various other embodiments, the sleeve 20 may be made of other metallic materials, such as metallic materials with a higher hardness and a less thickness than the conductive terminal 10.

According to the exemplary embodiment shown in FIG. 2, in the conductive terminal assembly 100 according to the present disclosure, the clip 23 can be embedded into the groove 13 by a stamping process. Since the sleeve 20 can be formed by bending rather than drawing-deep, this allows the stamping process and the assembly process to be integrated into a single mold, which significantly reduces the requirements for the roundness and dimensional variations of the two parts, thereby greatly reducing the manufacturing difficulty of the parts and ensuring a more stable product quality.

According to the exemplary embodiments shown in FIGS. 2, 3 and 7, the insertion portion 11 of the conductive terminal 10 has three contact units 14, 15, which are arranged at equal intervals around the circumferential direction of the insertion portion 11 to ensure that the entire insertion portion 11 is subjected to forces more evenly, and to prevent the conductive terminal 10 from being easily damaged. As shown in FIG. 3, each contact unit 14, 15 includes two contact portions for electrical contact with the mating terminal, namely a first contact portion 15A and a second contact portion 15B, which are spaced apart along the central axis of the insertion portion 11. When the mating terminal is inserted, the first contact portion 15A and the second contact portion 15B successively make contact with the mating terminal and form an electrical connection.

In the conductive terminal assembly 100 according to embodiments of the present disclosure, since at least two contact portions 15A, 15B are provided in the axial direction of the conductive terminal 10, the contact resistance is reduced, and the contact stability of the conductive terminal 10 and the mating terminal in the axial direction is improved, thereby improving the reliability of the connection between the conductive terminal 10 and the mating terminal.

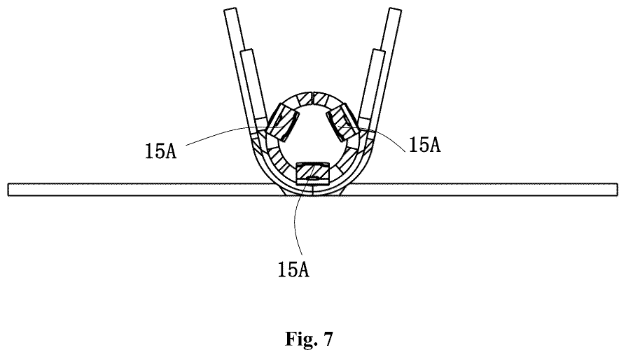

It should be noted that, although three contact units 14, 15 are shown in the embodiments illustrated in the Figures, such as, for example, FIG. 7, the number of contact units can also be other values, such as one, two, four, etc., in some other embodiments of the present disclosure. Furthermore, although the three contact units are arranged at equal intervals around the insertion portion 11 in the embodiments illustrated in the Figures, such as FIG. 7, the plurality of contact units can also be arranged at unequal intervals around the insertion portion 11 in some other embodiments of the present disclosure.

According to the exemplary embodiments of the present disclosure, as shown in FIGS. 2, 3 and 7, each contact unit 14, 15 includes two contact portions 15A, 15B for electrical contact with the mating terminal. However, in other embodiments of the present disclosure, each contact unit may also include a different number of contact portions, such as three, four, five, etc., which are arranged at intervals along the central axis of the insertion portion 11 to improve the contact stability between the conductive terminal 10 and the mating terminal in the axial direction.

According to the exemplary embodiments of the present disclosure, and, as shown in FIG. 2, the insertion portion 11 has a first cantilever 14A and a second cantilever 14B. The first cantilever 14A extends obliquely away from the insertion opening and towards the central axis of the insertion portion 11. The second cantilever 14B extends obliquely towards the insertion opening and towards the central axis of the insertion portion 11. As shown in FIG. 3, the first contact portion 15A is provided on the first cantilever 14A, and the first contact portion 15A is a portion of the overall first cantilever 14A closest to the central axis of the insertion portion 11. Similarly, the second contact portion 15B is provided on the second cantilever 14B, and the second contact portion 15B is a portion of the overall second cantilever 14B closest to the central axis of the insertion portion 11. The first cantilever 14A and the second cantilever 14B are connected by the circumferential side wall of the insertion portion 11. The first cantilever 14A and the second cantilever 14B extend while tilting towards the central axis of the insertion portion 11, so that the first contact portion 15A and the second contact portion 15B abut against the mating terminal when the mating terminal is inserted into the mating cavity. As shown in FIG. 3, the first contact portion 15A is formed at the free end of the first cantilever 14A, and the second contact portion 15B is formed at the free end of the second cantilever 14B.

According to another exemplary embodiment, the insertion portion 11 may have a first cantilever 14A and a second cantilever 14B. The first cantilever 14A extends obliquely away from the insertion opening and towards the central axis of the insertion portion 11. The second cantilever 14B also extends obliquely away from the insertion opening and towards the central axis of the insertion portion 11. Here, the first contact portion 15A is provided on the first cantilever 14A, and the first contact portion 15A is a portion of the overall first cantilever 14A closest to the central axis of the insertion portion 11. Similarly, the second contact portion 15B is provided on the second cantilever 14B, and the second contact portion 15B is a portion of the overall second cantilever 14B closest to the central axis of the insertion portion 11. That is, both the first cantilever 14A and the second cantilever 14B extend away from the insertion opening along the central axis of the insertion portion 11, and the first cantilever 14A and the second cantilever 14B extend while tilting towards the central axis of the insertion portion 11, so that the first contact portion 15A and the second contact portion 15B abut against the mating terminal when the mating terminal is inserted into the mating cavity. In an embodiment, the first contact portion 15A is formed at the free end of the first cantilever 14A, and the second contact portion 15B is formed at the free end of the second cantilever 14B.

It should be noted that, in the embodiment shown in FIG. 7, the first cantilevers 14A of all the contact units are aligned in the circumferential direction of the insertion portion 11, the first contact portion 15A is also aligned in the circumferential direction of the insertion portion 11, and the second cantilevers 14B of all the contact units are aligned in the circumferential direction of the insertion portion 11, and the second contact portion 15B is also aligned in the circumferential direction of the insertion portion 11. Additionally, the first cantilevers 14A of all the contact units and the first contact portion 15A can also be offset from each other in the circumferential direction of the insertion portion 11, and the second cantilevers 14B of all the contact units and the second contact portion 15B can also be offset from each other in the circumferential direction of the insertion portion 11 in other exemplary.

An exemplary embodiment of a conductive terminal assembly 100 will now be described with reference to FIG. 6. As shown in FIG. 6, the insertion portion 11 has a third cantilever 14, which extends obliquely away from the insertion opening and towards the central axis of the insertion portion 11. As shown in FIG. 6, both the first contact portion 15A and the second contact portion 15B are provided on the third cantilever 14. It should be noted that in some other embodiments of the present disclosure, the third cantilever 14 can also extend obliquely towards the insertion opening and towards the central axis of the insertion portion 11.

It should be noted that, although the third cantilevers 14, the first contact portion 15A, and the second contact portion 15B, of all the contact units 14, 15 are aligned in the circumferential direction of the insertion portion 11 in the embodiment shown in FIG. 6, the third cantilevers 14, the first contact portion 15A, and the second contact portion 15B, of all the contact units 14, 15 can also be offset from each other in the circumferential direction of the insertion portion 11 in some other embodiments of the present disclosure.

According to the exemplary embodiment shown in FIG. 6, a portion of the third cantilever 14 located between the first contact portion 15A and the second contact portion 15B protrudes outwardly away from the central axis of the insertion portion 11. The portion of the third cantilever 14 protrudes outwardly away from the central axis of the insertion portion 11 to abut against the sleeve 20 outside the insertion portion 11. This allows a force to be applied to the third cantilever 14 by the sleeve 20, thereby ensuring the stable contact between the two contact portions and the mating terminal.

According to the exemplary embodiments shown in FIGS. 3 and 6, the conductive terminal 10 further includes a wiring portion 12 located at an end opposite to the insertion portion 11 and an intermediate portion connecting the insertion portion 11 and the wiring portion 12. As shown in FIG. 3, the wiring portion 12 is U-shaped to fixedly hold and electrically connect the cable.

According to another aspect of the present disclosure, a connector is also provided. The connector comprises a housing and a conductive terminal assembly fixed in the housing, the conductive terminal assembly being the conductive terminal assembly 100 according to embodiments of the present disclosure.

In the conductive terminal assembly 100 and the connector according to various abovementioned embodiments of the present disclosure, a protrusion 23 protrudes from one of a side wall of the insertion portion 11 and a side wall of the sleeve 20 towards the other, and the protrusion 23 is engaged with the other of the side wall of the insertion portion 11 and the side wall of the sleeve 20, to suppress a movement of the sleeve 20 relative to the insertion portion 11. That is, with an interference between the sleeve 20 and the conductive terminal 10 only at the protrusion 23, the sensitivities of the conductive terminal assembly 100 to the dimensional and shape variations are reduced, the production efficiency is improved, and the manufacturing cost is reduced. Moreover, the protrusion 23 can be in the form of a clip 23, and the sleeve 20 and the conductive terminal 10 can be fixed together by forming a groove 13 that engages with the clip 23 in the other of the side wall of the insertion portion 11 and the side wall of the sleeve 20, thereby greatly improving the reliability of the connection between the conductive terminal 10 and the sleeve 20. In addition, the conductive terminal assembly 100 can be embedded into the groove 13 by a stamping process, since the sleeve 20 can be formed by bending rather than drawing-deep, this allows the stamping process and the assembly process to be integrated into a single mold, which significantly reduces the requirements for the roundness and dimensional variations of the two parts, thereby greatly lowering the manufacturing difficulty of the parts and ensuring more stable product quality.

It should be appreciated by those skilled in the art that the above embodiments are intended to be illustrative, and many modifications may be made to the above embodiments by those skilled in the art. Further, various structures described in various embodiments may be freely combined with each other without conflicting in configuration or principle.

Although the present disclosure has been described hereinbefore in detail with reference to the accompanying drawings, it should be appreciated that the disclosed embodiments in the accompanying drawings are intended to illustrate embodiments of the present disclosure by way of example, and should not be construed as limiting the present disclosure.

Although some embodiments of the general inventive concept of the present disclosure have been shown and described, it would be appreciated by those skilled in the art that changes or modification may be made to these embodiments without departing from the principles and spirit of the general inventive concept, the scope of which is defined in claims and their equivalents.

1. A conductive terminal assembly, comprising:
a conductive terminal having an end with an insertion portion, the insertion portion has an insertion cavity receiving a mating terminal;
a sleeve sleeved on an outside of the insertion portion; and
a locking structure fixing the sleeve and the insertion portion together, the locking structure has a protrusion protruding from one of a side wall of the insertion portion and a side wall of the sleeve towards the other, the protrusion is engaged with another of the side wall of the insertion portion and the side wall of the sleeve to suppress a movement of the sleeve relative to the insertion portion.

2. The conductive terminal assembly of claim 1, wherein the protrusion is formed in a shape of a clip.

3. The conductive terminal assembly of claim 2, wherein the locking structure includes a groove formed in the side wall of the insertion portion or the side wall of the sleeve, the clip engages with the groove.

4. The conductive terminal assembly of claim 2, wherein the clip is formed with a rib.

5. The conductive terminal assembly of claim 1, wherein the locking structure includes a groove formed in the side wall of the insertion portion or the side wall of the sleeve.

6. The conductive terminal assembly of claim 5, wherein the protrusion is formed as a segment of the sleeve, and the groove is in a form of a blind hole or a through hole.

7. The conductive terminal assembly of claim 1, wherein the sleeve is formed by bending a sheet metal.

8. The conductive terminal assembly of claim 3, wherein the clip is embedded into the groove by stamping.

9. The conductive terminal assembly of claim 1, wherein the protrusion is formed by bending the sleeve away from an insertion opening of the insertion cavity towards the insertion portion.

10. The conductive terminal assembly of claim 1, wherein the protrusion is formed by bending the insertion portion away from an insertion opening of the insertion cavity towards the sleeve.

11. The conductive terminal assembly of claim 1, wherein the locking structure is one of a plurality of locking structures, the plurality of locking structures are arranged at intervals along a circumferential direction of the sleeve.

12. The conductive terminal assembly of claim 1, wherein the locking structure is one of a plurality of locking structures, the plurality of locking structures are arranged at intervals along an axial direction of the sleeve.

13. The conductive terminal assembly of claim 1, wherein the sleeve has a sleeve body and a locking boss protruding outwardly from the sleeve body in a radial direction.

14. The conductive terminal assembly of claim 1, further comprising a stopper stopping a forward movement of the conductive terminal.

15. The conductive terminal assembly of claim 14, wherein the stopper is formed by bending an end of the sleeve corresponding to an insertion opening of the insertion cavity into the insertion cavity.

16. A connector, comprising:
a housing; and
a conductive terminal assembly fixed in the housing, the conductive terminal assembly
including a conductive terminal, a sleeve, and a locking structure, the conductive terminal has an end with an insertion portion, the insertion portion has an insertion cavity receiving a mating terminal, the sleeve is sleeved on an outside of the insertion portion, the locking structure fixes the sleeve and the insertion portion together, the locking structure has a protrusion protruding from one of a side wall of the insertion portion and a side wall of the sleeve towards the other, the protrusion is engaged with another of the side wall of the insertion portion and the side wall of the sleeve to suppress a movement of the sleeve relative to the insertion portion.
